(19) United States
(12) Patent Application Publication
(10) Pub. No.: US 2007/0213058 A1
(43) Pub. Date: Sep. 13, 2007

(54) METHOD AND APPARATUS FOR SUPPORTING HANDOFF AND SERVING RADIO NETWORK SUBSYSTEM RELOCATION PROCEDURES IN A SINGLE TUNNEL GPRS-BASED WIRELESS COMMUNICATION SYSTEM

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/626,538

(22) Filed: Jan. 24, 2007

Related U.S. Application Data
(60) Provisional application No. 60/780,233, filed on Mar. 8, 2006.

(51) Int. Cl. H04Q 7/20

(52) U.S. Cl. 455/436

(57) ABSTRACT

A serving radio network subsystem (SRNS) relocation method is implemented in a wireless communication system. When an old serving general packet radio service (GPRS) support node (SGSN) indicates that a source RNC requires SRNS relocation, the new SGSN sends a relocation request message to a target RNC indicating a single tunnel operation, a tunnel endpoint identity (TEID) of a gateway GPRS support node (GGSN), the identification number of a wireless transmit/receive unit (WTRU) and the packet data protocol (PDP) address of the WTRU. The new SGSN sends an update PDP context request message to the GGSN indicating a single tunnel operation and the target RNC TEID. The GGSN updates a binding of the target RNC TEID with the WTRU PDP address and the identification number. A new tunnel is established between the target RNC and the GGSN, and an old tunnel between the source RNC and the GGSN is released.

### CROSS REFERENCE TO RELATED APPLICATIONS

This application claims the benefit of U.S. Provisional Application No. 60/780,233 filed Mar. 8, 2006, which is incorporated by reference as if fully set forth.

### FIELD OF INVENTION

The present invention is related to a wireless communication system. More particularly, the present invention is related to a method and apparatus for supporting handoff and serving radio network subsystem (SRNS) relocation procedures in a single tunnel general packet radio service (GPRS)-based wireless communication system.

### BACKGROUND

FIG. 1 shows a conventional GPRS/third generation (3G) wireless communication system architecture 100 that shows various interfaces/protocols as well as user data transfer interfaces between various network entities. The wireless communication system 100 includes at least one serving GPRS support node (SGSN) 105 and at least one gateway GPRS support node (GGSN) 110. The wireless communication system 100 further comprises a universal terrestrial radio access network (UTRAN) 115 which includes one or more radio access networks (RANs), base station systems (BSSs) and radio network controllers (RNCs), (not shown). The system 100 also comprises a plurality of wireless transmit/receive units (WTRUs) 120, each including a terminal equipment (TE) 125 coupled to a mobile terminal (MT) 130. The mobility in the wireless communication system 100 is facilitated by anchoring an Internet Protocol (IP) session at the GGSN 110 and allowing for multi-level mobility by supporting mobility management (MM) protocols for IP and non-IP traffic/services provided by the SGSN 105.

FIG. 2A shows how dual tunnels are established in the conventional wireless communication system 100 of FIG. 1 to provide IP connectivity for user plane traffic. As shown in FIG. 2A, a GPRS tunnelling protocol (GTP) user plane (GTP-U) tunnel 220 is established between a GGSN 205 and an SGSN 210, and a second user plane tunnel 225 is established between the SGSN 210 and a radio network controller (RNC) 215. Both tunnels are dedicated to the same user. The GTP tunnel 220 has a user plane and a control plane. The user tunnel 225 is an IP tunnel having a user plane and a RAN application part (RANAP) control plane used for control messaging.

When an intra-SGSN handoff is implemented, the SGSN 210 switches the tunnel from an old RNC to a new RNC. A combined hard handover and SRNS relocation procedure is used to move the RAN to core network (CN) connection point at the RAN side from the source serving RNC (SRNC) to the target RNC, while performing a hard handover decided by the RAN. In the procedure, the Iu links are relocated. If the target RNC is connected to the same SGSN as the source SRNC, an intra-SGSN SRNS relocation procedure is performed. If the routing area is changed, this procedure is followed by an intra-SGSN routing area update procedure. The SGSN detects that it is an intra-SGSN routing area update by noticing that it also handles the old routing area. In this case, the SGSN has the necessary information about the WRTU and there is no need to inform the HLR about the new WTRU location.

If the target RNC is connected to a different SGSN than the source SRNC, an inter-SGSN SRNS relocation procedure is performed. This procedure is followed by an inter-SGSN routing area update procedure.

A routing area update (RAU) is used to minimize the paging traffic within a wireless communication system that is grouped into clusters. Each cluster includes a group of cells (Node-Bs). Each cluster is defined by a unique identifier, (i.e., routing area identifier (ID)). Those WTRUs in the wireless communication system that travel across boundaries of the clusters have to perform a registration process called a routing area update. In the RAU, the WTRU informs the core network regarding which area of the system it is operating in. If the WTRU receives a terminated call, the core network pages the WTRU in the last known routing area. This eliminates the need to send a paging message for the WTRU throughout the entire system, which in turn significantly reduces the amount of signalling across the system. Thus, more processing power is allocated to user traffic. The RAU may require the establishment of a new connection between a GGSN and a new RNC. New processes and message formats are needed for a single tunnel approach as compared to those existing in a two tunnel approach.

In the evolution toward an all IP Network (AIPN), most of the services and applications are migrating toward IP based platforms. This migration requires IP connectivity, and the generated traffic does not have to be terminated at the SGSN. Therefore, a single tunnel functionality is desirable to reduce the delay and processing power at the SGSN.

### SUMMARY

The present invention is related to a serving radio network subsystem (SRNS) relocation method which is implemented in a wireless communication system including at least one WTRU, a source RNC, a target RNC, an old SGSN, a new SGSN and a GGSN. An old GTP-U tunnel is established between the source RNC and the GGSN. The source RNC sends a relocation required message to the old SGSN. The old SGSN sends a forward relocation request message to the new SGSN. The new SGSN sends a relocation request message to the target RNC which indicates a single tunnel operation, a tunnel endpoint identity (TEID) of the GGSN, an identification number of the WTRU and the packet data protocol (PDP) address of the WTRU. The new SGSN sends an update PDP context request message to the GGSN which indicates a single tunnel operation and the TEID of the target RNC. The GGSN updates a binding of the target RNC TEID with the PDP address and the identification number of the WTRU. A new GTP-U tunnel is established between the target RNC and the GGSN, and the old GTP-U tunnel is released.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a conventional GPRS and 3G wireless communication system;

FIG. 2A shows the conventional establishment of dual tunnels;

FIG. 2B shows the establishment of a single tunnel in accordance with the present invention;

FIG. 3 shows a prior art tunnel protocol stack;

FIG. 4 shows a single tunnel protocol stack configured in accordance with the present invention;

FIG. 5 shows a single tunnel establishment procedure, (packet data protocol (PDP) context activation), which is implemented in accordance with the present invention;

FIG. 6 shows a system configuration before implementing SRNS relocation and routing area update using a single tunnel approach in accordance with the present invention;

FIG. 7 shows a system configuration after implementing an SRNS relocation procedure and routing area update using a single tunnel approach in accordance with the present invention;

FIG. 8 is a signaling diagram of an SRNS relocation procedure in accordance with the present invention;

FIG. 9 shows a system configuration before implementing a single tunnel combined hard handover and SRNS relocation and routing area update procedure in accordance with the present invention;

FIG. 10 shows a system configuration after implementing a single tunnel combined hard handover and SRNS relocation and routing area update procedure in accordance with the present invention; and

FIG. 11 is a signaling diagram of a single tunnel combined hard handover and SRNS relocation procedure in accordance with another embodiment of the present invention.

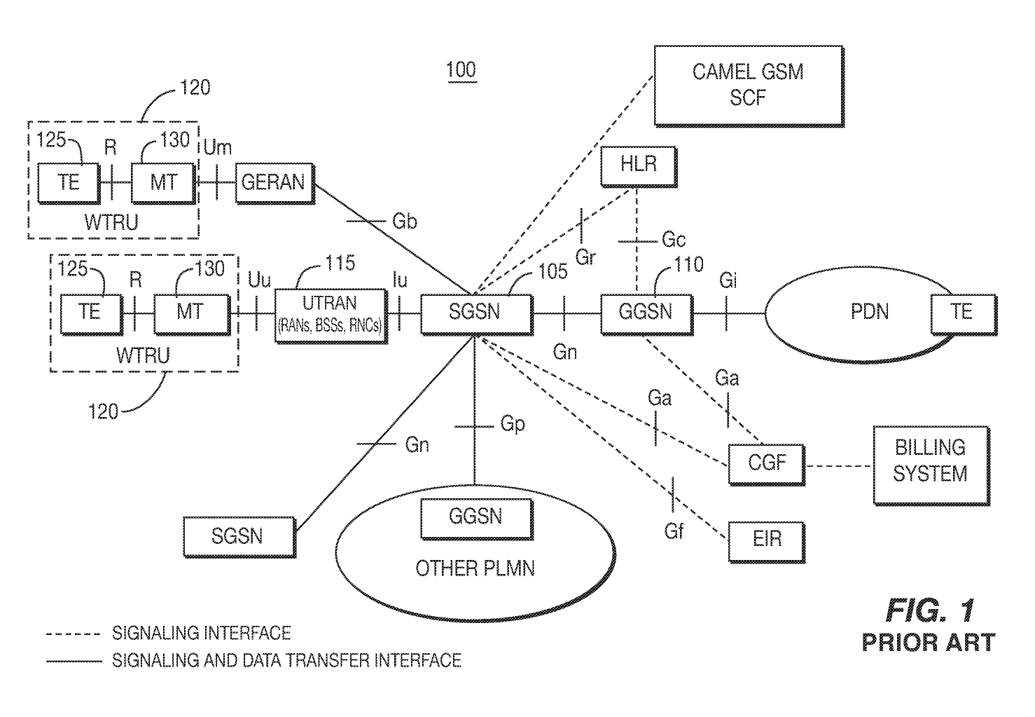

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The features of the present invention may be incorporated into an integrated circuit (IC) or be configured in a circuit comprising a multitude of interconnecting components.

In accordance with the present invention, the mobility in GPRS, (3G or beyond), systems is facilitated by anchoring the IP session at the home GGSN and allowing for multi-level mobility, and by supporting existing MM protocols for non-IP traffic/services provided by the SGSN.

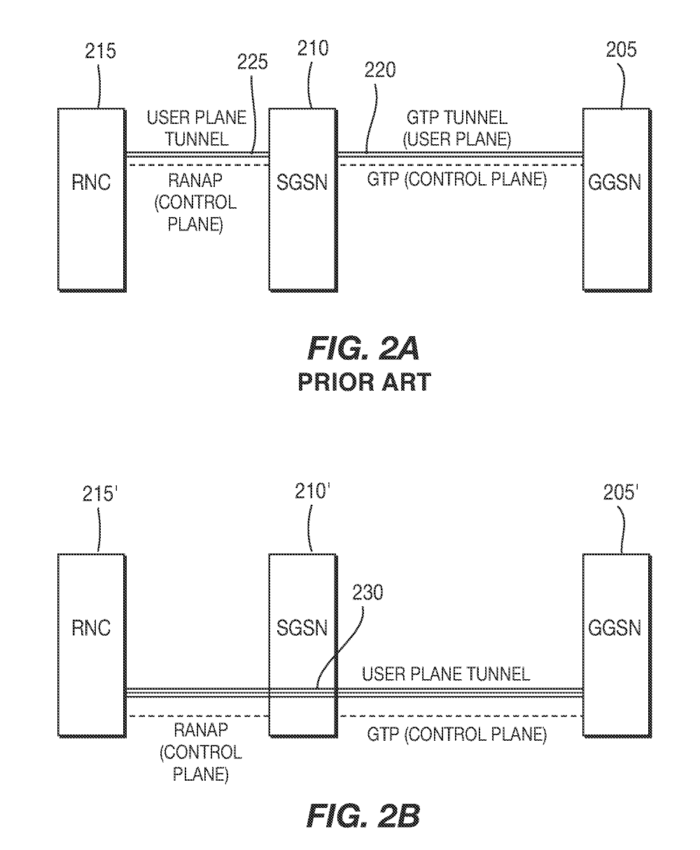

FIG. 2B shows a single user-plane tunnel approach in accordance with the present invention. A single user plane tunnel 230 is used to reduce the delay and processing power of an SGSN 210′. In the two-tunnel approach shown in FIG. 2A, the SGSN 210 terminates both the GTP tunnel 220 and a user plane tunnel 225 to the RNC 215, which means that the SGSN 210 decodes the packets traveling in both directions and translates them into the different protocol formats of the two tunnels 220 and 225. In a single tunnel approach shown in FIG. 2B, the SGSN 210′ only establishes a tunnel between the GGSN 205′ and the RNC 215′ via two separate interfaces/protocols, (RANAP-C and GTP-C). In the single tunnel approach, the SGSN 210′ is no longer involved in the user plane traffic. Thus, the user traffic passes through the SGSN 210′ unchanged, (i.e., unaltered), in both directions. The SGSN 210′ is no longer involved in the user plane processing. Only the RNC 215′ and the GGSN 205′ are allowed to perform/act on the user plane traffic. The SGSN 210′ only manages the control traffic, including MM, RAU, and the like, associated with the user and its IP based traffic. The SGSN 210′ connects an RNC 215′ and a GGSN 205′ using a GTP control plane to communicate with the GGSN 205′ and a RANAP control plane to communicate with the RNC 215′. When a handoff occurs between RNCs, the SGSN 210′ is responsible for providing the GGSN 205′ with the new RNC TEID information and the establishment of the single tunnel 230.

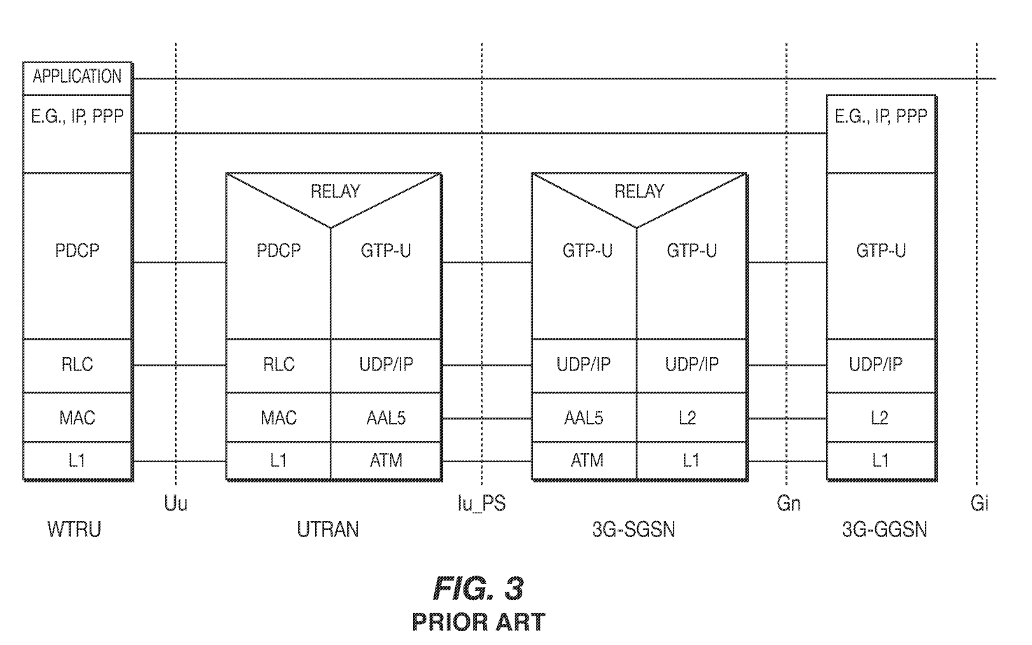

FIG. 3 shows a prior art tunnel protocol stack according to existing GPRS protocol. A GTP-U tunnel transfers, (i.e., tunnels), user data between a UTRAN (which includes RANs, BSSs and RNCs) and a 3G-SGSN, and between the 3G-SGSN and a 3G-GGSN.

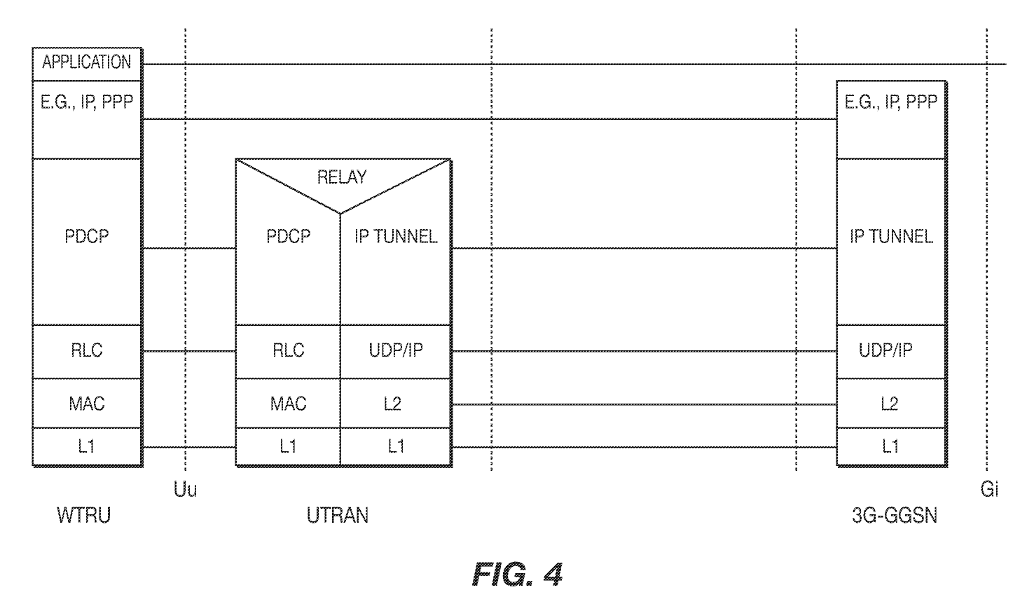

FIG. 4 shows a user plane in the single tunnel protocol stack in accordance with the present invention, in which the user plane tunnel from the UTRAN does not terminate at the 3G-SGSN. Instead, the UTRAN terminates at the 3G-GGSN. The IP Tunnel shown in UTRAN and GGSN can be GTP based or any generic IP-Tunnel. In a preferred embodiment, the GTP-U tunnel is used as an IP tunnel.

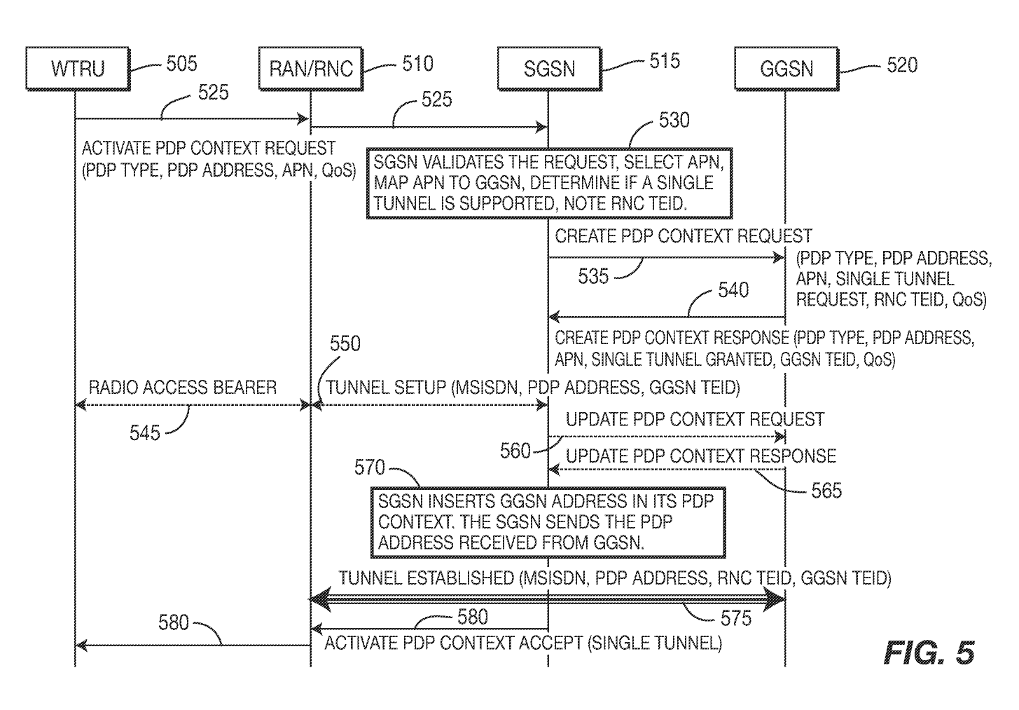

FIG. 5 is a signaling diagram of a process for single tunnel establishment in accordance with the present invention. The single tunnel functionality reduces the delay and processing power at the SGSN by reducing the need for protocol translation between the RNC and GGSN interfaces, and by enabling direct user plane tunnel between the RAN/RNC and the GGSN within the packet switched (PS) domain. However, the single tunnel approach will not eliminate the need for the SGSN to manage control traffic for IP based traffic. The SGSN is still needed for the control plane signalling, MM and call/session management, and makes a decision when to establish a single tunnel rather than establishing dual tunnels.

In the case of a single tunnel, the SGSN should connect the RAN/RNC TEID and the GGSN TEID for user plane by informing each end point of the tunnel of the corresponding TEID of the other end point, (i.e., informing the GGSN of the RNC TEID and informing the RNC of the GGSN TEID). In the case of a handoff between RNCs, the SGSN is responsible for updating and providing the GGSN with new RNC TEID information and the establishment of the single tunnel.

FIG. 5 shows a single tunnel establishment procedure, (packet data protocol (PDP) context activation), which is implemented in a wireless communication system including a WTRU 505, a radio access network (RAN)/radio network controller (RNC) 510, an SGSN 515 and a GGSN 520 in accordance with the present invention. The WTRU 505 sends an activate PDP context request to the SGSN 515 that includes PDP type, PDP address, APN, quality of service (QoS) data and the like), (step 525). The SGSN 515 validates the activate PDP context request, selects an APN), and maps the APN to the GGSN 520 (step 530). The SGSN 515 determines if a single tunnel is supported and/or requested, and notes the existence of an RNC TEID (step 530). The SGSN 515 creates a PDP context request that includes PDP Type, PDP Address, APN, a single tunnel request, an RNC TEID, QoS and the like), (step 535). The GGSN 520 creates a PDP context response that includes PDP Type, PDP Address, APN, an indicator that the single tunnel is granted, GGSN TEID, QoS and the like (step 540). The WTRU 505 and the RAN/RNC 510 establish a radio access bearer (RAB) (step 545). In step 550, the SGSN 515 and the RAN/RNC 510 exchange tunnel setup signaling that includes a mobile station international subscriber directory number (MSISDN), a PDP address and a GGSN TEID, and the SGSN 515 sends tunnel establishment information to the RAN/RNC 510 after receiving an indication of acceptance from the GGSN to establish the tunnel. The SGSN 515 sends an update PDP context request to the GGSN 520 (step 560) to establish the new tunnel by informing the GGSN 520 of the RNC TEID associated with the request, and the GGSN 520 sends an update PDP context response to the SGSN 515 (step 565) confirming/rejecting the establishment of the tunnel and the associated attributes, (RNC TEID, PDP type, PDP address, user ID, and the like). The SGSN 515 inserts the GGSN address in its PDP context, sends the PDP address received from the GGSN (step 570) and prepares for the response to be sent down to the WTRU 505. Thus, if necessary, the SGSN 515 updates the PDP context in the GGSN 520 to reflect any changes in the QoS attributes resulting from the RAB establishment of step 545. Tunnel establishing signaling is exchanged between the RAN/RNC 510 and the GGSN 520 including the MSISDN, PDP address, RNC TEID and GGSN TEID (step 575). The SGSN 515 sends an activate PDP context accept signal to the WTRU 505 that indicates the presence of a single tunnel (step 580).

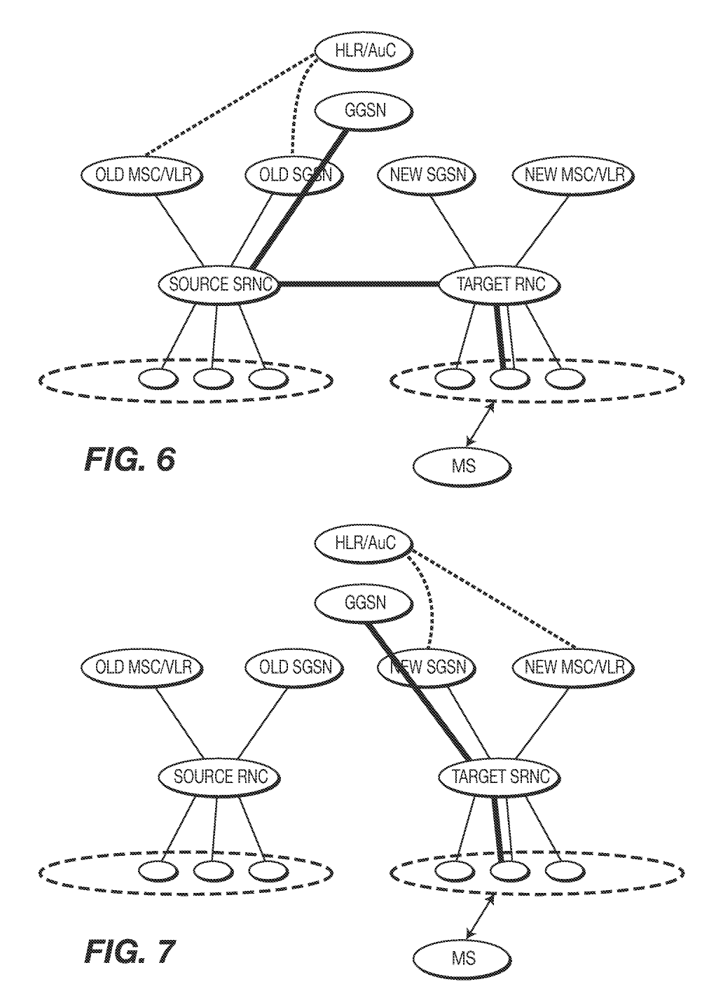

FIG. 6 shows a system configuration before implementing a handover procedure in accordance with the present invention.

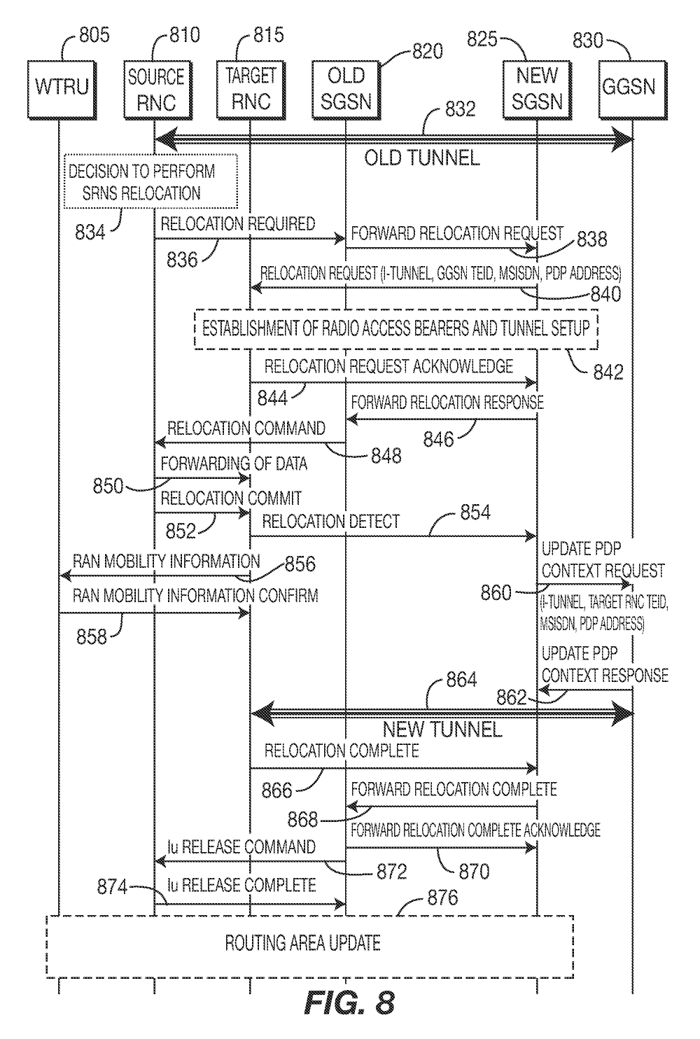

FIG. 7 shows a system configuration after implementing a handover procedure that uses SRNS relocation and routing area update using a single tunnel approach in accordance with the present invention. The single tunnel between the GGSN and the source RNC, (when the source RNC takes the role of a serving RNC (SRNC)) shown in FIG. 6 is switched to a new single tunnel between the GGSN and the target RNC during a handover procedure, (when the target RNC takes the role of an SRNC), as shown in FIG. 7 after performing the SRNS relocation and routing area update of FIG. 8.

FIG. 8 is a signaling diagram of an SRNS relocation procedure using a single tunnel approach implemented in a wireless communication system including a WTRU 805, a source RNC 810, a target RNC 815, an old SGSN 820, a new SGSN 825 and a GGSN 830 in accordance with one embodiment of the present invention.

In step 832, an old tunnel is established between the source RNC 810 and the GGSN 830.

In step 834, the source RNC 810 decides to perform/initiate SRNS relocation. At this point, both uplink and downlink user data flows via at least one of the following tunnels: a radio bearer between the WTRU 805 and the source RNC 810, (data flows via the target RNC 815, which acts as a drift RNC); GTP user plane tunnel(s) between the source RNC 810 and the old SGSN 820; and GTP user plane tunnel(s) between the old-SGSN 820 and the GGSN 830.

In step 836, the source RNC 810 sends a relocation required message, (including relocation type, cause, source ID, target ID, source RNC to target RNC transparent container), to the old SGSN 820. The source RNC 810 sets the relocation type to “WTRU not involved”. The source RNC to target RNC transparent container includes the necessary information for relocation coordination, security functionality and radio resource control (RRC) protocol context information, (including WTRU capabilities).

The old SGSN 820 determines from the target ID if the SRNS relocation is an intra-SGSN SRNS relocation or an inter-SGSN SRNS relocation. In the case of an inter-SGSN SRNS relocation, the old SGSN 820 initiates the relocation resource allocation procedure by sending a forward relocation request message, (IMSI, TEID signaling, MM context, PDP context, target identification, RAN transparent container, RANAP cause) to the new SGSN 825 (step 838). For relocation to an area where intra domain connection of RAN nodes to multiple CN nodes is used, the old SGSN 820 may, (if it provides intra domain connection of RAN nodes to multiple CN nodes), have multiple target SGSNs for each relocation target in a pool area, in which case the old SGSN 820 will select one of them to become the new SGSN 825. The PDP context contains a GGSN address for user plane and uplink TEID for data, (to this GGSN address and uplink TEID, for data the old SGSN 820 and the new SGSN 825 send uplink packets). At the same time, a timer is started on the MM and PDP contexts in the old SGSN 820. The forward relocation request message of step 838 is applicable only in the case of inter-SGSN SRNS relocation.

In step 840, the new SGSN 825 sends a relocation request message, (including a permanent non-access stratum (NAS) WTRU identity, cause, CN domain indicator, source RNC to target RNC transparent container, RABs to be setup), to the target RNC 815.

In accordance with the present invention, the relocation request message also indicates a single tunnel operation, the TEID of the GGSN 830 and the association between both the MSISDN of the WTRU 805 and its PDP address with the TEID of the GGSN 830

In step 842, RABs are established and a tunnel setup at the target RNC 815 is established in accordance with the present invention. Only the Iu bearers of the RABs are setup between the target RNC 815 and the new SGSN 825, since the existing RABs will be reallocated between the WTRU 805 and the target RNC 815 when the target RNC 815 takes the role of an SRNC. For each requested RAB, the RAB's information elements may contain information such as RAB ID, RAB parameters, transport layer address and Iu transport association. The RAB ID information element contains the network layer service access point identifier (NSAPI) value, and the RAB parameters information element provides the quality of service (QoS) profile. The transport layer address is the SGSN address for user data, and the Iu transport association corresponds to the uplink TEID data.

After all necessary resources for accepted RABs including the Iu user plane are successfully allocated, the target RNC 815 sends a relocation request acknowledge message, (RABs setup, RABs failed to setup), to the new SGSN 825 (step 844). Each RAB to be setup is defined by a transport layer address, which is the address of the target RNC 815 for user data, and an Iu transport association, which corresponds to the downlink TEID for user data. For each RAB to be set up, the target RNC 815 may receive simultaneously downlink user packets both from the source RNC 810 and from the new SGSN 825.

When resources for the transmission of user data between the target RNC 815 and the new SGSN 825 have been allocated, and the new SGSN 825 is ready for relocation of SRNS, a forward relocation response message, (cause, RANAP cause, and RAB setup information), is sent from the new SGSN 825 to the old SGSN 820 (step 846). The forward relocation response message indicates that the target RNC 815 is ready to receive from source RNC 810 the forwarded downlink PDUs, (i.e., the relocation resource allocation procedure is terminated successfully). The RANAP cause is information from the target RNC 815 to be forwarded to the source RNC 810. The RAB setup information, one information element for each RAB, contains the RNC TEID and the RNC IP address for data forwarded from the source RNC 810 to the target RNC 815. If the target RNC 815 or the new SGSN 825 failed to allocate resources, the RAB setup information element contains only NSAPI indicating that the source RNC 810 shall release the resources associated with the NSAPI. The forward relocation response message of step 846 is applicable only in case of inter-SGSN SRNS relocation.

The old SGSN 820 continues the relocation of SRNS by sending a relocation command message, (RABs to be released, and RABs subject to data forwarding), to the source RNC 810 (step 848). The old SGSN 820 determines the RABs to be subject for data forwarding based on QoS, and those RABs shall be contained in RABs subject to data forwarding. For each RAB subject to data forwarding, the information element shall contain an RAB ID, transport layer address, and Iu transport association. These are the same transport layer address and Iu transport association that the target RNC 815 had sent to the new SGSN 825 in the relocation request acknowledge message of step 844, and these are used for forwarding of downlink PDUs from the source RNC 810 to the target RNC 815. The source RNC 810 is now ready to forward downlink user data directly to the target RNC 815 over the Iu interface. This forwarding is performed for downlink user data only.

In step 850, the source RNC 810 may, according to the QoS profile, begin the forwarding of data to the target RNC 815 for the RABs to be subject for data forwarding. The data forwarding at SRNS relocation shall be carried out through the Iu interface, meaning that the data exchanged between the source RNC 810 and the target RNC 815 are duplicated in the source RNC 810 and routed at IP layer towards the target RNC 815. For each radio bearer which uses a lossless packet data convergence protocol (PDCP), the GTP-PDUs related to transmitted but not yet acknowledged PDCP-PDUs are duplicated and routed at IP layer towards the target RNC 815 together with their related downlink PDCP sequence numbers. The source RNC 810 continues transmitting duplicates of downlink data and receiving uplink data. Before the role of the serving RNC is not yet taken over by the target RNC 815, and when downlink user plane data starts to arrive at the target RNC 815, the target RNC 815 may buffer or discard arriving downlink GTP-PDUs according to the related QoS profile.

It should be noted that the order of steps 850-876 of the SRNS relocation procedure shown in FIG. 8 does not necessarily reflect the order of events and may be performed in a different order or simultaneously. For instance, the source RNC 810 may start data forwarding in step 850 and send a relocation commit message (step 852) almost simultaneously except in the delivery order required case where step 850 triggers step 852. The target RNC 815 may send a relocation detect message (step 854) and a RAN mobility information message (step 856) at the same time. Hence, the target RNC 815 may receive a RAN mobility information confirm message (step 858) while data forwarding (step 850) is still underway, and before the new SGSN 825 receives an update PDP context response message (step 862).

Before sending the relocation commit message at step 852 for the uplink and downlink data transfer in the source RNC 810, the source RNC 810 is suspended for RABs, which require delivery order. The source RNC 810 shall start the data-forwarding timer. When the source RNC 810 is ready, the source RNC 810 triggers the execution of relocation of SRNS by sending a relocation commit message, (SRNS contexts), to the target RNC 815 over the Iur interface (step 852). The purpose of this procedure is to transfer SRNS contexts from the source RNC 810 to the target RNC 815, and to move the SRNS role from the source RNC 810 to the target RNC 815. SRNS contexts are sent for each concerned RAB and contain the sequence numbers of the GTP-PDUs next to be transmitted in the uplink and downlink directions and the next PDCP sequence numbers that would have been used to send and receive data from the WTRU 805. For PDP context(s) using delivery order not required (QoS profile), the sequence numbers of the GTP-PDUs next to be transmitted are not used by the target RNC 815. PDCP sequence numbers are only sent by the source RNC 810 for radio bearers, which used lossless PDCP. The use of lossless PDCP is selected by the source RNC 810 when the radio bearer is set up or reconfigured.

If delivery order is required (QoS profile), consecutive GTP-PDU sequence numbering shall be maintained throughout the lifetime of the PDP context(s). Therefore, during the entire SRNS relocation procedure for the PDP context(s) using delivery order required (QoS profile), the responsible GTP-U entities, (RNCs and GGSN), shall assign consecutive GTP-PDU sequence numbers to user packets belonging to the same PDP context for uplink and downlink, respectively.

In step 854, the target RNC 815 sends a relocation detect message to the new SGSN 825 when the relocation execution trigger is received. For SRNS relocation type “WTRU not involved”, the relocation execution trigger is the reception of the relocation commit message at step 852 from the Iur interface. When the relocation detect message is sent at step 854, the target RNC 815 shall start SRNC operation.

At step 856, the target RNC 815 sends a RAN mobility information message that contains WTRU information elements and CN information elements. The WTRU information elements include, among others, a new SRNC identity and a subscriber radio network temporary identity (S-RNTI). The CN information elements contain, among others, location area identification and routing area identification. The procedure is coordinated in all Iu signaling connections existing for the WTRU 805.

The target RNC 815 establishes and/or restarts the RLC, and exchanges the PDCP sequence numbers, (PDCP sequence number (SNU), PDCP sequence number downlink (SND)), between the target RNC 815 and the WTRU 805. The PDCP SND is the PDCP sequence number for the next expected in-sequence downlink packet to be received in the WTRU 805 per radio bearer, which used lossless PDCP in the source RNC 810. The PDCP SND confirms all mobile-terminated packets successfully transferred before the SRNC relocation. If the PDCP SND confirms reception of packets that were forwarded from the source RNC 810, the target RNC 815 shall discard these packets. The PDCP SNU is the PDCP sequence number for the next expected in-sequence uplink packet to be received in the RNC per radio bearer, which used lossless PDCP in the source RNC 810. The PDCP SNU confirms all WTRU originated packets successfully transferred before the SRNC relocation. If PDCP SNU confirms reception of packets that were received in the source RNC 810, the WTRU 805 shall discard these packets.

Upon reception of the RAN mobility information message at step 856, the WTRU 805 may start sending uplink user data to the target RNC 815. When the WTRU 805 has reconfigured itself, it sends a RAN mobility information confirm message to the target RNC 815 at step 858. This indicates that the WTRU 805 is also ready to receive downlink data from the target RNC 815.

In step 860, the new SGSN 825 sends an update PDP context request message to the GGSN 830 at step 860 which indicates a single tunnel configuration and the TEID of the target RNC 815 in accordance with the present invention. In response, the GGSN 830 updates the binding of the TEID of the target RNC 815 with the PDP address and the MSISDN of the WTRU 805. Thus, SGSN 825 sends the name of the new connection that data will be forwarded to by the GGSN 830. Once this information is received, the GGSN 830 updates the information pertaining to this tunnel, (i.e., new destination).

For all of the RABs, the target RNC 815 starts uplink reception of data and start transmission of uplink GTP-PDUs towards the new SGSN 825, and the target RNC 815 starts processing the already buffered and the arriving downlink GTP-PDUs and starts downlink transmission towards the WTRU 805.

Upon receipt of the relocation detect message at step 854, the CN may switch the user plane from the source RNC 810 to the target RNC 815. If the SRNS relocation is an inter-SGSN SRNS relocation, the new SGSN 825 sends update PDP context request messages, (new SGSN address, SGSN TEID, QoS negotiated), to the GGSNs concerned. The GGSNs update their PDP context fields and return an update PDP context response (GGSN TEID) at step 862. A new GTP user plane tunnel is then established between the target RNC 815 and the GGSN 830 at step 864 in accordance with the present invention.

If the new SGSN 825 has already received the update PDP context response message from the GGSN 830, the new SGSN 825 forwards the uplink user data to the GGSN 830 over the new GTP user plane tunnel. Otherwise, the new SGSN 825 forwards the uplink user data to the IP address of the GGSN 830 and TEID(s), which the new SGSN 825 had received earlier by the forward relocation request message at step 838.

When the target RNC 815 receives the RAN mobility information confirm message at step 858, (i.e., the ID of the target RNC 815 and an S-RNTI are successfully exchanged with the WTRU 805 by the radio protocols), the target RNC 815 initiates a relocation complete procedure by sending a relocation complete message to the new SGSN 825 at step 866.

The purpose of the relocation complete procedure is to indicate by the target RNC 815 the completion of the SRNS relocation to the CN. If the user plane has not been switched at relocation detect and upon reception of relocation complete, the CN switches the user plane from the source RNC 810 to the target RNC 815. If the SRNS relocation is an inter-SGSN SRNS relocation, the new SGSN 825 signals to the old SGSN 820 the completion of the SRNS relocation procedure by sending a forward relocation complete message at step 868.

Upon receiving the forward relocation complete message, or if an inter-SGSN SRNS relocation is taking place, the old SGSN 820 sends a forward relocation complete acknowledge message to the new SGSN at step 870, and the old SGSN 820 sends an Iu release command message to the source RNC 810 at step 872. When the RNC data-forwarding timer expires, the source RNC 810 responds with an Iu release complete message at step 874.

After the WTRU 805 has finished the RNTI reallocation procedure and, if the new routing area identification is different from the old one, the WTRU 805 initiates a routing area update procedure at step 876.

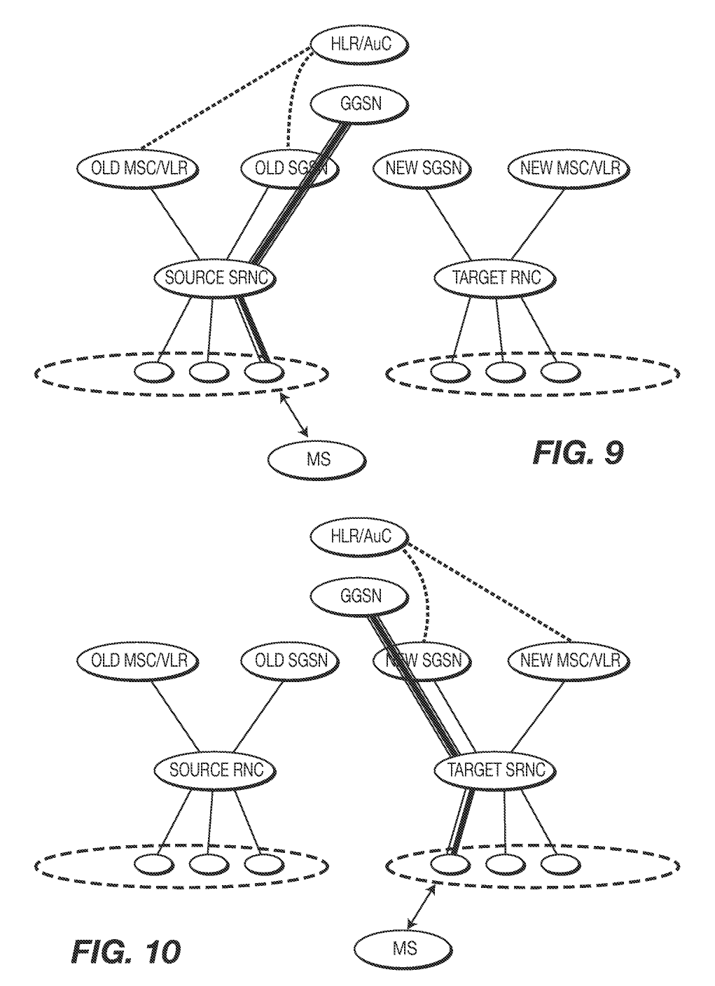

FIG. 9 shows a system configuration before implementing a single tunnel combined hard handover and SRNS relocation and routing area update procedure in accordance with the present invention.

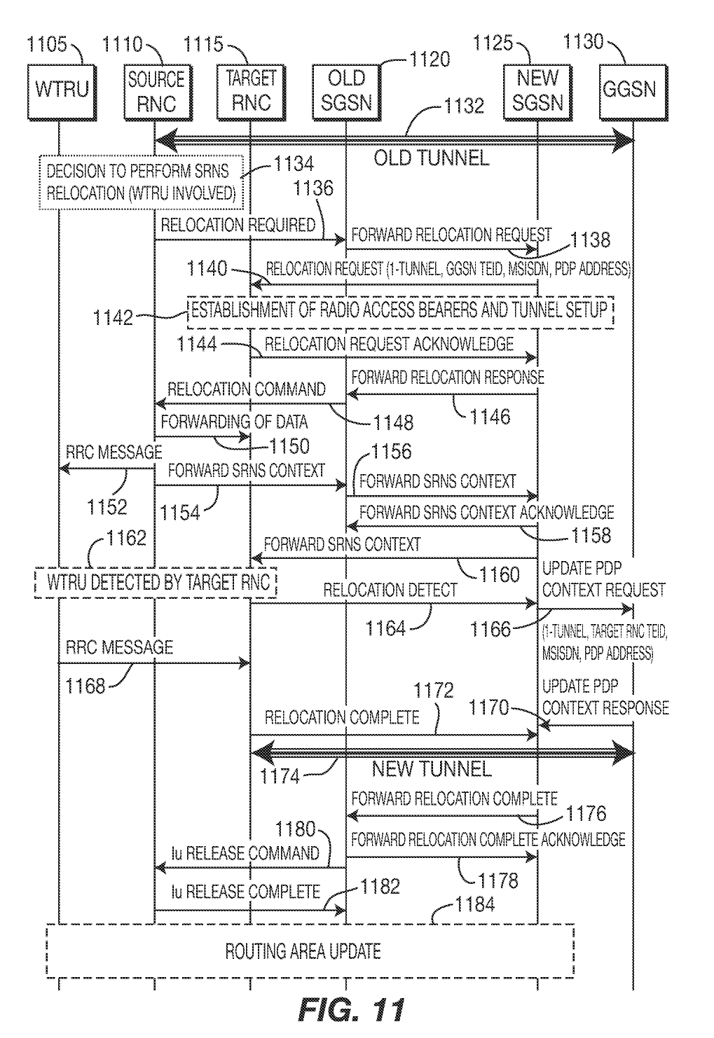

FIG. 10 shows a system configuration after implementing a single tunnel combined hard handover and SRNS relocation and routing area update procedure in accordance with the present invention.

FIG. 11 is a signaling diagram of a single tunnel combined hard handover and SRNS relocation procedure implemented in a wireless communication system including a WTRU 1105, a source RNC 1110, a target RNC 1115, an old SGSN 1120, a new SGSN 1125 and a GGSN 1130 in accordance with another embodiment of the present invention. The procedure of FIG. 11 is applicable to both intra-SGSN SRNS relocation and inter-SGSN SRNS relocation. Furthermore, the signaling flow is applicable to BSS to RNS relocation and vice-versa, as well as BSS to BSS relocation.

In step 1132, an old tunnel is established between the source RNC 1110 and the GGSN 1130.

In step 1134, the source RNC 1110 decides to perform/initiate a combined hard handover and SRNS relocation. At this point, both uplink and downlink user data flows via at least one of the following tunnels: a radio bearer between the WTRU 1105 and the source RNC 1110, (no drift RNC available); GTP user plane tunnel(s) between the source RNC 1110 and the old SGSN 1120; and GTP user plane tunnel(s) between the old-SGSN 1120 and the GGSN 1130.

In step 1136, the source RNC 1110 sends a relocation required message, (including relocation type, cause, source ID, target ID, source RNC to target RNC transparent container), to the old SGSN 1120. The source RNC 1110 sets the relocation type to “WTRU involved”. The source RNC to target RNC transparent container includes the necessary information for relocation coordination, security functionality and RRC protocol context information, (including WTRU capabilities).

The old SGSN 1120 determines from the target ID if the SRNS relocation is an intra-SGSN SRNS relocation or an inter-SGSN SRNS relocation. In the case of an inter-SGSN SRNS relocation, the old SGSN 1120 initiates the relocation resource allocation procedure by sending a forward relocation request message, (IMSI, TEID signaling, MM context, PDP context, target identification, RAN transparent container, RANAP cause) to the new SGSN 1125 (step 1138). For relocation to an area where intra domain connection of RAN nodes to multiple CN nodes is used, the old SGSN 1120 may, (if it provides intra domain connection of RAN nodes to multiple CN nodes), have multiple target SGSNs for each relocation target in a pool area, in which case the old SGSN 1120 will select one of them to become the new SGSN 1125. The PDP context contains a GGSN address for user plane and uplink TEID for data, (to this GGSN address and uplink TEID, for data the old SGSN 1120 and the new SGSN 1125 send uplink packets). At the same time, a timer is started on the MM and PDP contexts in the old SGSN 1120. The forward relocation request message of step 1138 is applicable only in the case of inter-SGSN SRNS relocation.

In step 1140, the new SGSN 1125 sends a relocation request message, (including a permanent non-access stratum (NAS) WTRU identity, cause, CN domain indicator, source RNC to target RNC transparent container, RABs to be setup), to the target RNC 1115. For relocation to an area where intra domain connection of RAN nodes to multiple CN Nodes is used, the old SGSN 1120 may, if it provides intra domain connection of RAN nodes to multiple CN nodes, have multiple target SGSNs for each relocation target in a pool area, in which case the old SGSN 1120 will select one of them to become the new SGSN 1125. PDP context contains a GGSN address for user plane and uplink TEID for data, (to this GGSN address and uplink TEID for data. The old SGSN 1120 and the new SGSN 1125 send uplink packets). At the same time, a timer is started on the MM and PDP contexts in the old SGSN 1120. The forward relocation request message is applicable only for inter-SGSN SRNS relocation.

In accordance with the present invention, the relocation request message also indicates a single tunnel operation, the TEID of the GGSN 1130 and the association between both the MSISDN of the WTRU 1105 and its PDP address with the TEID of the GGSN 1130.

In step 1142, RABs are established and a tunnel setup at the target RNC 1115 is established in accordance with the present invention. Only the Iu bearers of the RABs are setup between the target RNC 1115 and the new SGSN 1125, since the existing RABs will be reallocated between the WTRU 1105 and the target RNC 1115 when the target RNC 1115 takes the role of an SRNC. For each requested RAB, the RAB's information elements may contain information such as RAB ID, RAB parameters, transport layer address and Iu transport association. The RAB ID information element contains the network layer service access point identifier (NSAPI) value, and the RAB parameters information element provides the quality of service (QoS) profile. The transport layer address is the SGSN address for user data, and the Iu transport association corresponds to the uplink TEID data.

After all necessary resources for accepted RABs including the Iu user plane are successfully allocated, the target RNC 1115 sends a relocation request acknowledge message, (RABs setup, RABs failed to setup), to the new SGSN 1125 (step 1144). Each RAB to be setup is defined by a transport layer address, which is the address of the target RNC 1115 for user data, and an Iu transport association, which corresponds to the downlink TEID for user data. For each RAB to be set up, the target RNC 1115 may receive simultaneously downlink user packets both from the source RNC 1110 and from the new SGSN 1125.

When resources for the transmission of user data between the target RNC 1115 and the new SGSN 1125 have been allocated, and the new SGSN 1125 is ready for relocation of SRNS, a forward relocation response message, (cause, RAN transparent container, RANAP cause, target-RNC information), is sent from the new SGSN 1125 to the old SGSN 1120 (step 1146). The forward relocation response message indicates that the target RNC 1115 is ready to receive from the source RNC 1110 the forwarded downlink PDUs, (i.e., the relocation resource allocation procedure is terminated successfully). The RAN transparent container and the RANAP cause are information from the target RNC 1115 to be forwarded to the source RNC 1110. The target RNC information, one information element for each RAB to be set up, contains the RNC TEID and the RNC IP address for data forwarded from the source RNC 1110 to the target RNC 1115. The forward relocation response message of step 1146 is applicable only for inter-SGSN SRNS relocation.

The old SGSN 1120 continues the relocation of SRNS by sending a relocation command message, (RABs to be released, and RABs subject to data forwarding), to the source RNC 1110 (step 1148). The old SGSN 1120 determines the RABs to be subject for data forwarding based on QoS, and those RABs shall be contained in RABs subject to data forwarding. For each RAB subject to data forwarding, the information element shall contain an RAB ID, transport layer address, and Iu transport association. These are the same transport layer address and Iu transport association that the target RNC 1115 had sent to the new SGSN 1125 in the relocation request acknowledge message of step 1144, and these are used for forwarding of downlink PDUs from the source RNC 1110 to the target RNC 1115. The source RNC 1110 is now ready to forward downlink user data directly to the target RNC 1115 over the Iu interface. This forwarding is performed for downlink user data only.

In step 1150, the source RNC 1110 may, according to the QoS profile, begin the forwarding of data to the target RNC 1115 for the RABs to be subject for data forwarding. The data forwarding at SRNS relocation shall be carried out through the Iu interface, meaning that the data (GTP-PDUs) exchanged between the source RNC 1110 and the target RNC 1115 are duplicated in the source RNC 1110 and routed at the IP layer towards the target RNC 1115. For each radio bearer which uses a lossless packet data convergence protocol (PDCP), the GTP-PDUs related to transmitted but not yet acknowledged PDCP-PDUs are duplicated and routed at IP layer towards the target RNC 1115 together with their related downlink PDCP sequence numbers. The source RNC 1110 continues transmitting duplicates of downlink data and receiving uplink data. Before the role of the serving RNC is not yet taken over by the target RNC 1115, and when downlink user plane data starts to arrive at the target RNC 1115, the target RNC 1115 may buffer or discard arriving downlink GTP-PDUs according to the related QoS profile.

It should be noted that the order of steps 1150-1184 of the single tunnel combined hard handover and SRNS relocation procedure shown in FIG. 11 does not necessarily reflect the order of events and may be performed in a different order or simultaneously. For instance, the source RNC 1110 may start data forwarding in step 1150, send an RRC message to the WTRU 1105 (step 1152) and forward SRNS context message to the old SGSN (step 1154) almost simultaneously.

Before sending the RRC message in step 1152, the uplink and downlink data transfer is suspended in the source RNC 1110 for RABs, which require delivery order. The RRC message is, for example, physical channel reconfiguration for RNS to RNS relocation, or intersystem to UTRAN handover for BSS to RNS relocation, or handover from UTRAN command for BSS relocation, or handover command for BSS to BSS relocation. When the source RNC 1110 is ready, the source RNC 1110 triggers the execution of relocation of SRNS by sending to the WTRU 1105 the RRC message provided in the target RNC 1115 to source RNC 1110 transparent container, e.g., a physical channel reconfiguration (WTRU information elements, CN information elements) message (step 1152). WTRU information elements include, among others, a new SRNC identity and S-RNTI. CN information elements contain, among others, location area identification and routing area identification.

The source RNC 1110 continues the execution of relocation of SRNS by sending a forward SRNS context (RAB contexts) message to the target RNC 1115 via the old SGSN 1120 and the new SGSN 1125 (steps 1154, 1156 and 1160). The forward SRNS context message is acknowledged by a forward SRNS context acknowledge message, from new SGSN 1125 to the old SGSN 1120 (step 1158). The purpose of this procedure is to transfer SRNS contexts from the source RNC 1110 to the target RNC 1115, and to move the SRNS role from the source RNC 1110 to the target RNC 1115. SRNS contexts are sent for each concerned RAB and contain the sequence numbers of the GTP PDUs next to be transmitted in the uplink and downlink directions and the next PDCP sequence numbers that would have been used to send and receive data from the WTRU 1105. PDCP sequence numbers are only sent by the source RNC 1110 for the radio bearers which used lossless PDCP. The use of lossless PDCP is selected by the source RNC 1110 when the radio bearer is set up or reconfigured. For PDP context(s) using delivery order not required (QoS profile), the sequence numbers of the GTP-PDUs next to be transmitted are not used by the target RNC 1115.

If delivery order is required (QoS profile), consecutive GTP-PDU sequence numbering shall be maintained throughout the lifetime of the PDP context(s). Therefore, during the entire SRNS relocation procedure for the PDP context(s) using delivery order required (QoS profile), the responsible GTP-U entities (the RNCs 1110 and 1115, and the GGSN 1130) shall assign consecutive GTP-PDU sequence numbers to user packets belonging to the same PDP context uplink and downlink, respectively.

The target RNC 1115 establishes and/or restarts the RLC and exchanges the PDCP sequence numbers, (PDCP-SNU, PDCP-SND), between the target RNC1115 and the WTRU 1105. PDCP-SND is the PDCP sequence number for the next expected in-sequence downlink packet to be received by the WTRU 1105 per radio bearer, which used lossless PDCP in the source RNC 1110. PDCP-SND confirms all mobile terminated packets successfully transferred before the SRNC relocation. If PDCP-SND confirms reception of packets that were forwarded from the source RNC 1110, then the target RNC 1115 shall discard these packets. PDCP-SNU is the PDCP sequence number for the next expected in-sequence uplink packet to be received in the RNC per radio bearer, which used lossless PDCP in the source RNC 1110. PDCP-SNU confirms all mobile originated packets successfully transferred before the SRNC relocation. If PDCP-SNU confirms reception of packets that were received in the source RNC 1110, the WTRU 1105 discards these packets.

The target RNC 1115 sends a relocation detect message to the new SGSN 1164 when the relocation execution trigger is received (step 1164). For SRNS relocation type “WTRU involved”, the relocation execution trigger may be received from the Uu interface; (i.e., when the target RNC 1115 detects the WTRU 1105 on the lower layers (step 1162)). When the relocation detect message is sent at step 1164, the target RNC 1115 starts SRNC operation.

In step 1166, the new SGSN 1125 sends an update PDP context request message to the GGSN 1130 which indicates a single tunnel configuration and the TEID of the target RNC 1115 in accordance with the present invention. In response, the GGSN 1130 updates the binding of the TEID of the target RNC 1115 with the PDP address and the MSISDN of the WTRU 1105.

For all of the RABs, the target RNC 1115 starts uplink reception of data and start transmission of uplink GTP-PDUs towards the new SGSN 1125, and the target RNC 1115 starts processing the already buffered and the arriving downlink GTP-PDUs and starts downlink transmission towards the WTRU 1105.

Upon receipt of the relocation detect message at step 1164, the CN may switch the user plane from the source RNC 1110 to the target RNC 1115. If the SRNS relocation is an inter-SGSN SRNS relocation, the new SGSN 1125 sends update PDP context request messages, (new SGSN address, SGSN TEID, QoS negotiated), to the GGSNs concerned. The GGSNs update their PDP context fields and return an update PDP context response (GGSN TEID) at step 1170. A new GTP user plane tunnel is the established between the target RNC 1115 and the GGSN 1130 at step 1174 in accordance with the present invention.

If the new SGSN 1125 has already received the update PDP context response message from the GGSN 1130, the new SGSN 1125 forwards the uplink user data to the GGSN 1130 over the new GTP user plane tunnel. Otherwise, the new SGSN 1125 forwards the uplink user data to the IP address of the GGSN 1130 and TEID(s), which the new SGSN 1125 had received earlier by the forward relocation request message at step 1138.

When the WTRU 1105 has reconfigured itself, it sends an RRC message, (e.g., a physical channel reconfiguration complete message), to the target RNC 1115 (step 1168). If a forward SRNS context message with the sequence numbers is received at step 1160, the exchange of packets with the WTRU 1105 may start. If this message is not yet received, the target RNC 1115 may start the packet transfer for all RABs, which do not require maintaining the delivery order.

When the target RNC 1115 receives the RRC message at step 1168, the target RNC 1115 initiates a relocation complete procedure by sending a relocation complete message to the new SGSN 1125 at step 1172. The purpose of the relocation complete procedure is to indicate by the target RNC 1115 the completion of the SRNS relocation to the CN. If the user plane has not been switched at relocation detect and upon reception of relocation complete, the CN switches the user plane from the source RNC 1110 to the target RNC 1115. If the SRNS relocation is an inter-SGSN SRNS relocation, the new SGSN 1125 signals to the old SGSN 1120 the completion of the SRNS relocation procedure by sending a forward relocation complete message at step 1176.

Upon receiving the forward relocation complete message, or if an inter-SGSN SRNS relocation is taking place, the old SGSN 1120 sends a forward relocation complete acknowledge message to the new SGSN at step 1178, and the old SGSN 1120 sends an Iu release command message to the source RNC 1110 at step 1180. When the RNC data-forwarding timer expires, the source RNC 1110 responds with an Iu release complete message at step 1182.

After the WTRU 1105 has finished the reconfiguration procedure and if the new routing area identification is different from the old one, the WTRU 1105 initiates a routing area update procedure at step 1184.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A serving radio network subsystem (SRNS) relocation method implemented in a wireless communication system including at least one wireless transmit/receive unit (WTRU), a source radio network controller (RNC), a target RNC, a first serving general packet radio service (GPRS) support node (SGSN), a second SGSN and a gateway GPRS support node (GGSN), wherein a first GPRS tunnelling protocol (GTP) user plane (GTP-U) tunnel is established between the source RNC and the GGSN, the method comprising:
(a) the source RNC sending a relocation required message to the first SGSN;
(b) the first SGSN sending a forward relocation request message to the second SGSN;
(c) the second SGSN sending a relocation request message to the target RNC which indicates a single tunnel operation, a tunnel endpoint identity (TEID) of the GGSN, an identification number of the WTRU and the packet data protocol (PDP) address of the WTRU;
(d) establishing a second GTP-U tunnel between the target RNC and the GGSN; and
(e) releasing the first GTP-U tunnel.

2. The method of claim 1 further comprising:
(f) the second SGSN sending an update PDP context request message to the GGSN which indicates a single tunnel operation and the TEID of the target RNC.

3. The method of claim 2 further comprising:
(g) the GGSN updating a binding of the target RNC TEID with the PDP address of the WTRU and the identification number of the WTRU prior to executing step (d).

4. A wireless communication system for implementing a serving radio network subsystem (SRNS) relocation procedure, the system comprising:
(a) at least one wireless transmit/receive unit (WTRU);
(b) a gateway general packet radio service (GPRS) support node (GGSN);
(c) a first serving GPRS support node (SGSN);
(d) a second SGSN that sends a relocation request message to the target RNC in response to receiving a forward relocation request message sent by the first SGSN, the relocation request message indicating a single tunnel operation, a tunnel endpoint identity (TEID) of the GGSN, an identification number of the WTRU and the packet data protocol (PDP) address of the WTRU;
(e) a source radio network controller (RNC) that sends a relocation required message to the first SGSN;
(f) a target RNC; and
(g) a first GPRS tunnelling protocol (GTP) user plane (GTP-U) tunnel that is established between the source RNC and the GGSN, wherein a second GTP-U tunnel is established between the target RNC and the GGSN and the first GTP-U tunnel is released when the SRNS relocation procedure is implemented.

5. The system of claim 4 wherein the second SGSN sends an update PDP context request message to the GGSN which indicates a single tunnel operation and the TEID of the target RNC.

6. The system of claim 5 wherein the GGSN updates a binding of the target RNC TEID with the PDP address of the WTRU and the identification number of the WTRU prior to establishing the second GTP-U tunnel.

7. A wireless communication system for implementing a single tunnel combined hard handover and serving radio network subsystem (SRNS) relocation procedure, the system comprising:
(a) at least one wireless transmit/receive unit (WTRU);
(b) a gateway general packet radio service (GPRS) support node (GGSN);
(c) a first serving GPRS support node (SGSN);
(d) a second SGSN that sends a relocation request message to the target RNC in response to receiving a forward relocation request message sent by the first SGSN, the relocation request message indicating a single tunnel operation, a tunnel endpoint identity (TEID) of the GGSN, an identification number of the WTRU and the packet data protocol (PDP) address of the WTRU;
(e) a target RNC;
(f) a source radio network controller (RNC) that sends a radio resource control (RRC) message to the WTRU, and sends a forward SRNS content message to the target RNC via the first SGSN and the second SGSN; and
(g) a first GPRS tunnelling protocol (GTP) user plane (GTP-U) tunnel that is established between the source RNC and the GGSN, wherein a second GTP-U tunnel is established between the target RNC and the GGSN and the first GTP-U tunnel is released when the combined hard handover and SRNS relocation procedure is implemented.

8. The system of claim 7 wherein the second SGSN sends an update PDP context request message to the GGSN which indicates a single tunnel operation and the TEID of the target RNC.

9. The system of claim 8 wherein the GGSN updates a binding of the target RNC TEID with the PDP address of the WTRU and the identification number of the WTRU prior to establishing the second GTP-U tunnel.

10. A combined hard handover and serving radio network subsystem (SRNS) relocation method implemented in a wireless communication system including at least one wireless transmit/receive unit (WTRU), a source radio network controller (RNC), a target RNC, a first serving general packet radio service (GPRS) support node (SGSN), a second SGSN and a gateway GPRS support node (GGSN), wherein a first GPRS tunnelling protocol (GTP) user plane (GTP-U) tunnel is established between the source RNC and the GGSN, the method comprising:
(a) the first SGSN sending a forward relocation request message to the second SGSN;
(b) the second SGSN sending a relocation request message to the target RNC which indicates a single tunnel operation, a tunnel endpoint identity (TEID) of the GGSN, an identification number of the WTRU and the packet data protocol (PDP) address of the WTRU;
(c) the source RNC sending a radio resource control (RRC) message to the WTRU;
(d) the source RNC sending a forward SRNS content message to the target RNC via the first SGSN and the second SGSN;
(e) establishing a second GTP-U tunnel between the target RNC and the GGSN; and
(f) releasing the first GTP-U tunnel.

11. The method of claim 10 further comprising:
(g) the second SGSN sending an update PDP context request message to the GGSN which indicates a single tunnel operation and the TEID of the target RNC.

12. The method of claim 11 further comprising:
(h) the GGSN updating a binding of the target RNC TEID with the PDP address of the WTRU and the identification number of the WTRU prior to executing step (e).
